(19) United States
(12) Patent Application Publication
(10) Pub. No.: US 2017/0000105 A1
(43) Pub. Date: Jan. 5, 2017

(54) ANIMAL CAGE TRAP

(71) Applicant: Neil Ziegmann, Lake View, IA (US)

(72) Inventor: Neil Ziegmann, Lake View, IA (US)

(21) Appl. No.: 15/199,062

(22) Filed: Jun. 30, 2016

Related U.S. Application Data
(60) Provisional application No. 62/187,361, filed on Jul. 1, 2015.

(51) Int. Cl. A01M 23/18; A01M 23/08

(52) U.S. Cl. CPC A01M 23/18; A01M 23/08

(57) ABSTRACT

A live animal cage trap has a door and a trigger which are continuously connected by a rod, such that when the door opens, the trigger automatically sets and when the trigger is tripped, the door automatically closes by gravity. No springs are provided on the trap. A slide lock on the door prevents the door from being opened by an animal inside the cage. A trigger guard is provided inside the cage to prevent trigger damage by an animal in the cage.

### CROSS-REFERENCE TO RELATED APPLICATIONS

This is an application which claims priority to Provisional Application U.S. Ser. No. 62/187,361, filed on Jul. 1, 2015, which is herein incorporated by reference in its entirety.

### BACKGROUND OF THE INVENTION

Animal cage traps are known in a variety of embodiments for live trapping of animals. These traps generally include a cage with a door movable between open and closed positions. The trap can be set with the door in the open position, and with bait inside the cage. As the animal moves towards the bait, it trips a trigger to release the catch and thereby close the door and trap the animal inside the cage.

Live animal traps utilize various triggers which reside within the trap and are connected to the door such that when the animal trips the trigger, the door closes to capture the animal. Some traps utilize a floor pan trigger. However, animals may get to the bait while avoiding the floor pan, such that the door does not close. Other traps utilize a wire arm within the cage as the trigger. However, raccoons and other animals are known to destroy the wire trigger when trapped inside the cage, thus necessitating repair after the animal is removed.

Setting the trap is oftentimes difficult and/or tricky. For example, some cages require a wire or rod to be connected to the trigger when setting the trap, with the rod or wire being released from the trigger when the animal trips the trigger. Connecting the rod or wire to the trigger takes time and practice, and the rod/wire can be inadvertently released when moving the set trap to a desired location or position.

Some traps have spring biased doors, which can be hazardous to the user if the door accidentally closes while setting the trap.

Therefore, there is a need for an improved and simplified live animal cage trap which can be quickly and easily set without risk of injury to the operator and which. securely traps the animal without chance of escape.

Accordingly, a primary objective of the present invention is the provision of improved live animal cage trap.

Another objective of the present invention is the provision of live animal cage trap which can be quickly, easily, and safely set,

A further objective of the present invention is the provision of live animal cage trap which securely contains an animal within the trap.

Still another objective of the present invention is live animal cage trap which will not accidentally release after being set.

Yet another objective of the present invention is the provision of a live animal cage trap wherein the rod connecting the trigger and the door remains connected, and not disconnected, when the animal actuates the trigger to close the door.

A further objective of the present invention is the provision of a live animal cage trap which can be set using only one hand.

Another objective of the present invention is the provision of a live animal cage trap wherein the trigger is protected from damage by the animal after the animal is trapped.

Another objective of the present invention is the provision of a live animal cage trap which. is economical to manufacture, durable in use, and easy to transport.

These and other objectives will become apparent from the following description of the invention.

### SUMMARY OF THE INVENTION

A live animal cage trap includes wire or perforated walls which define a compartment for containing an animal, such as a raccoon. A door is pivotably connected at an upper edge at one end of the compartment for movement between a raised open position and a lowered closed position. A trigger is provided inside the cage and is moveable between a raised tripped position and a lowered set position. A catch extends from the trigger and outside the cage to selectively hold the trigger in the set position. A rod extends between the catch and the door to maintain the door in the open position when the trigger is in the set position. The rod. does not disconnect from the trigger or from the door during use of the trap. A lock is slidably mounted on the door and moves between a raised unlocked positions when the door is open and a lowered locked position when the door is closed to prevent the entrapped animal from pushing the door open and escaping.

A trigger guard is provided inside the cage to protect the trigger from damage by the animal after the animal is trapped. The trap door is free from spring forces or energy. Sliding the lock form the lowered position to raised position, and lifting the door from the closed position to the open position can be done with one hand, and automatically moves the trigger to the set position via the connecting rod.

### DESCRIPTION OF THE DRAWINGS

FIG. 1 is a perspective view of the live animal cage trap according to the present invention, with the door in a closed position and the trigger in a raised non-use position.

FIG. 2 is a perspective view of the live animal cage trap according the present invention, with the door in a raised position and the trigger in a set position.

FIG. 3 is a side elevation view of the trap with the door in the open position and the trigger in the set position.

FIG. 4 is another side elevation view of the trap, with the door in the closed position and the trigger in the closed position.

FIG. 5 is an end elevation view of the cage showing the trigger in the set position.

FIG. 6 is an end elevation view of the cage showing the trigger in the raised tripped position within the trigger guard.

FIG. 7 is a plan view looking upwardly from inside the cage showing the trigger in the raised, guarded position, taken along line 7-7 of FIG. 1.

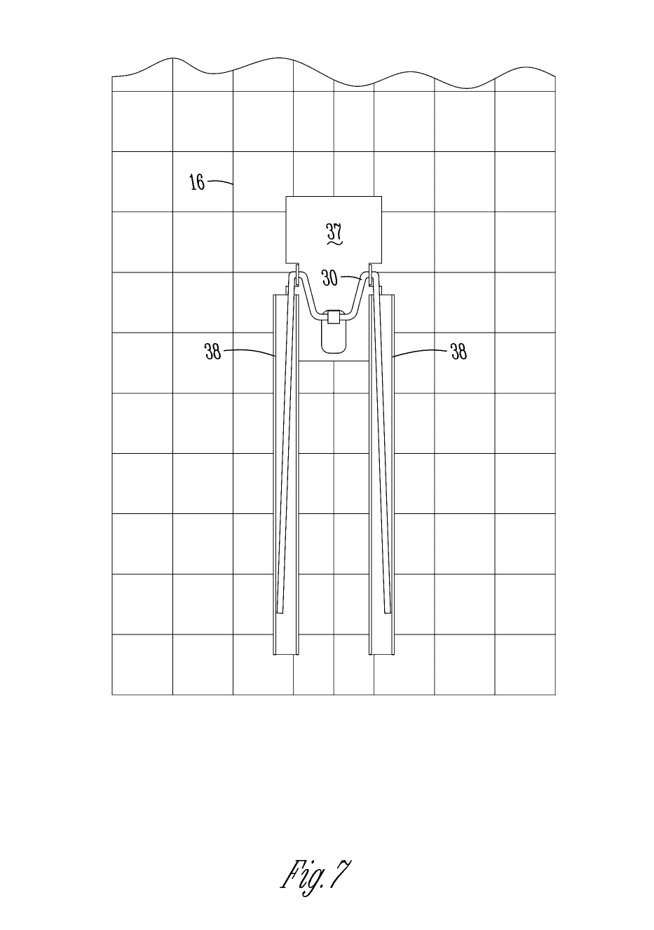

### DETAILED DESCRIPTION OF THE INVENTION

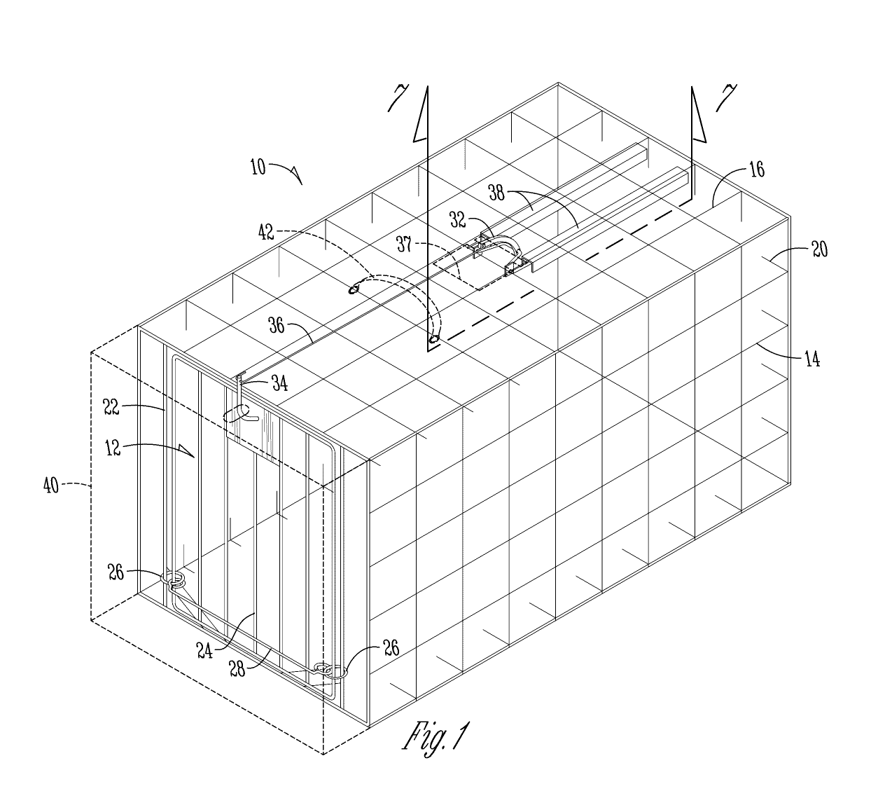

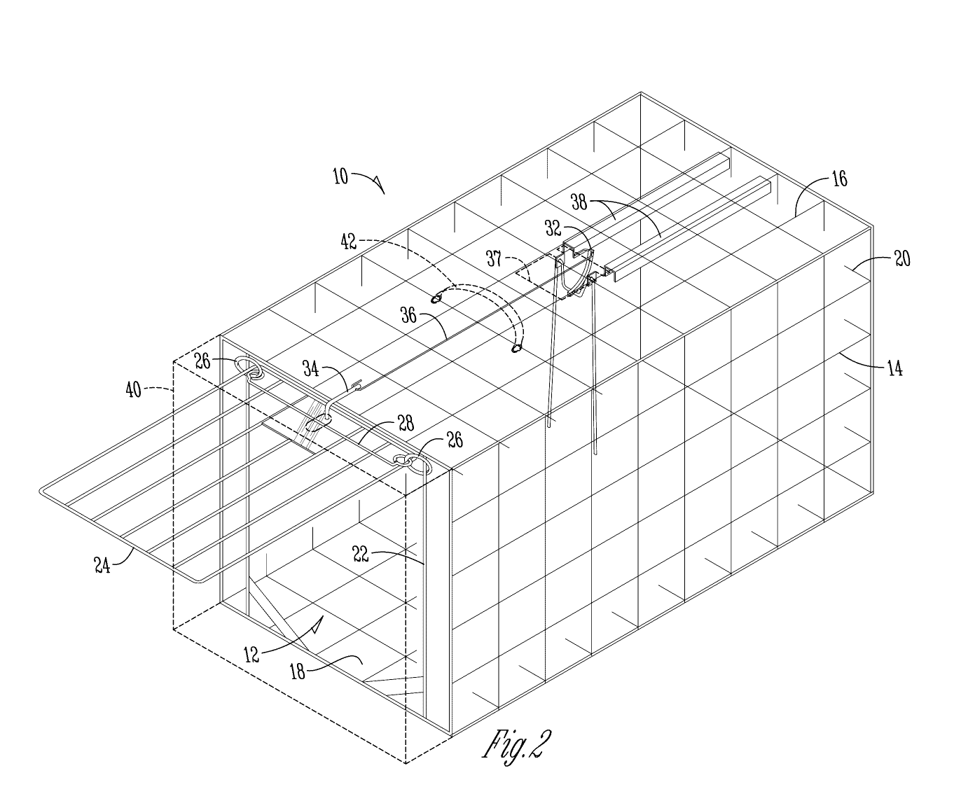

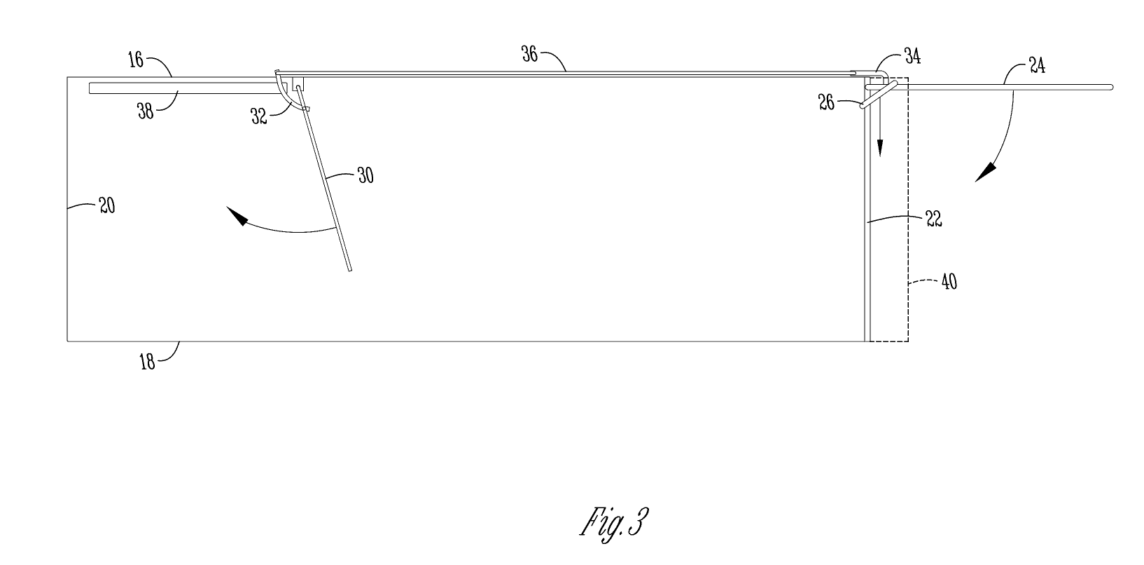

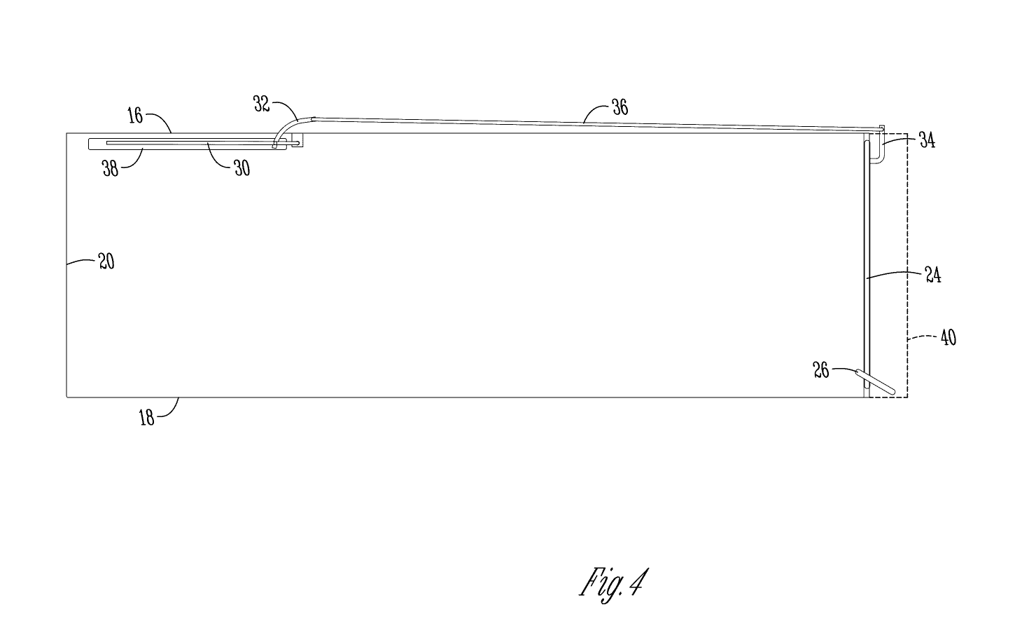

The animal cage trap 10 of the present invention is used for live capture of animals. The trap 10 has an animal compartment 12 defined by side walls 14, a top wall 16, a bottom wall 18, a rear wall 20, and a front wall 22 with a door 24. The door 24 is pivotally connected to the top wall 16 at a front end of the trap 10 so as to pivot between a closed position, as seen in FIGS. 1 and 4, and an open position, as seen in FIGS. 2 and 3. It is understood that the walls of the trap can be formed from mesh, as shown in the figures, or alternatively by expanded or perforated sheet metal, other materials having breathing holes, or solid materials.

The door 24 is normally in a closed position, and retained in the closed position by at least one ring 26 or slide member encircling the doorframe and an adjacent side of the door, as shown in photograph 1. In a preferred embodiment, a pair of rings 26 are provided, one on each side of the door, interconnected by a bar 28. The bar 28 has eyelets at opposite ends through which the rings 26 loosely extend. The rings 26 prevent an animal within the trap 10 from pushing the door 24 open, since the door will only open When the ring or rings 26 are slid upwardly to the top of the door, as seen in FIGS. 2 and 3. If the door includes rings on opposite side edges with the interconnecting bar 28, a trapper can use one hand on the bar 28 to slide both rings 26 upwardly simultaneously to the top of the door 24, which allows the door to be pivoted to the open position using the same hand. The eyelets on the ends of the bar 28 prevent the rings 26 from binding when moving upwardly and downward along the door 24 and door frame.

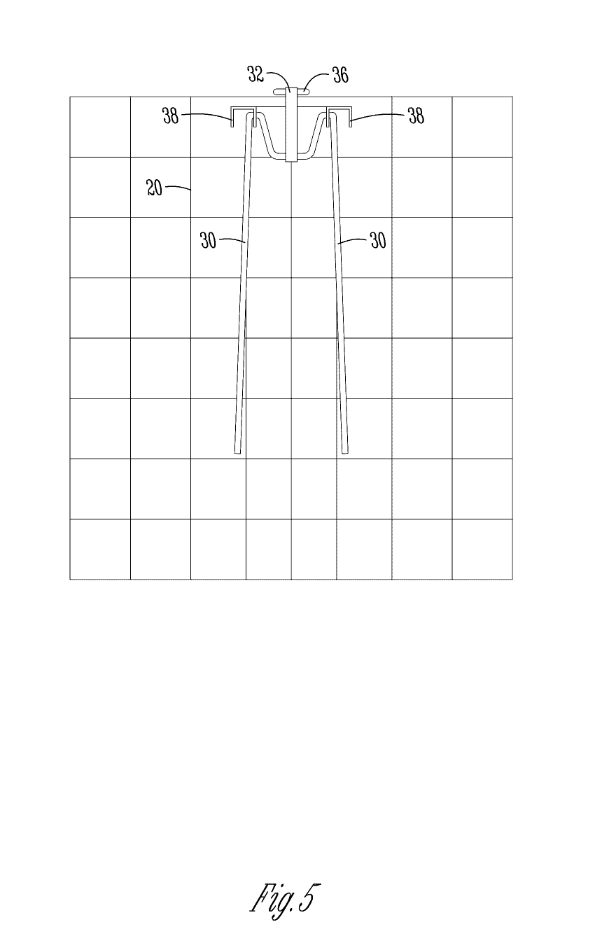

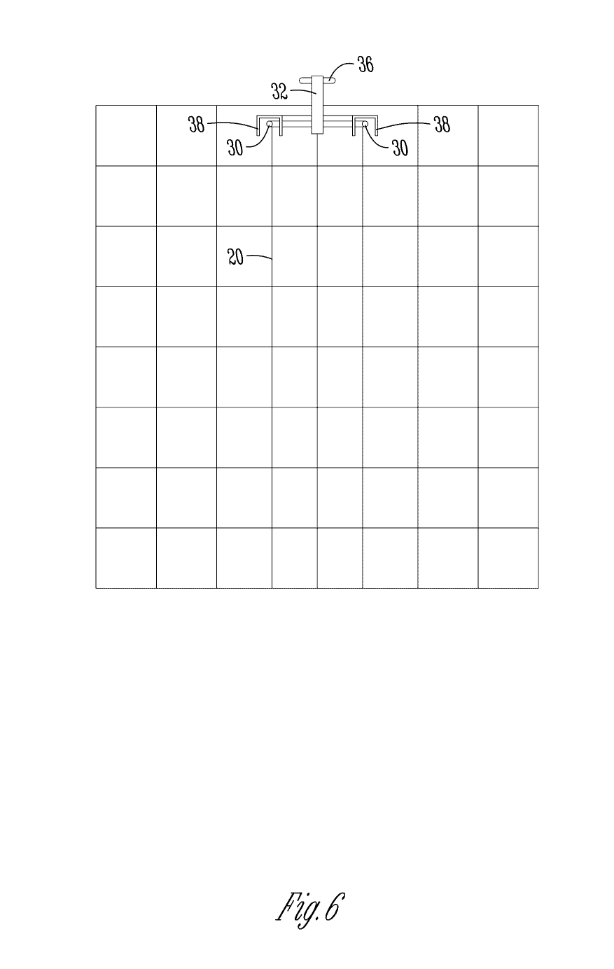

Opening the door 24 to a horizontal position automatically sets a catch and trigger assembly of the trap. The assembly is mounted on the top 16 of the trap 16, preferably closer to the rear wall 20 than the front wall 22. The catch and trigger assembly includes one or more trigger arms 30 which are pivotally mounted to the top wall 16 so as to move from a raised position inside the trap and adjacent the top wall when the door 24 is closed (as best seen in FIGS. 1, 4 and 6), to a downwardly extending position when the door 24 is fully opened (as best seen in FIGS. 2, 3 and 5).

The catch and trigger assembly also includes a first curved leg or dog 32 connected to the trigger arm(s) 30, and a second curved leg or dog 34 connected to the door 24. A connecting rod 36 extends between the curved legs 32, 34 outside the trap 10 and adjacent the top wall 16. When the door 24 is closed, the upper end of the door leg 34 extends vertically upwardly, while the connecting end of the catch leg 32 extends substantially horizontally above the top wall, as seen in FIG. 4. When the door 24 is opened to set the trigger 30, the door leg 34 pivots around or over the upper front corner of the trap 10 until the end of the leg 34 extends horizontally above the top wall 16, and the catch leg 34 is pushed rearwardly through the top wall 16 so that the connecting end extends substantially vertically, as seen in FIG. 3. Thus, opening the door 24 pivots the trigger arm(s) 30 from the raised position adjacent the top wall 16 to the lowered position extending substantially across the interior of the trap, via the door leg 34, the catch leg 32, and the interconnecting rod 36. The catch assembly includes a mounting plate 37 (shown in broken lines in FIGS. 1 and 2 for clarity), which retains the catch leg 32 in the set position. The connecting rod 36 does not disconnect from the legs 32, 34 at any time, such that the door 24 and trigger arms 30 are always connected, contrary to the prior art wherein the door and trigger are disconnected when the trap is tripped and must be reconnected when setting the trap.

A trigger guard 38 is mounted on the inside of the top wall 16, and is generally configured as downwardly facing U-shaped channels having a profile matching the shape of the trigger arms 30. When the trigger arms 30 are in the raised position with the door 24 closed, the arms 30 reside within the channels of the trigger guard 38 and are protected by the guard from access by an animal trapped in the compartment 12. Thus, the trigger 30 cannot be damaged by the animal inside the trap,

Bait can be placed inside the trap between the rear wall 20 and the trigger arm(s) 30. In an alternative embodiment, a bait and release door (not shown) can be provided at the rear end of the cage for setting the bait into the trap. When an animal is enticed through the open front door 24 into the trap 10 by the bait, the animal will contact the trigger 30 before getting to the bait. As the animal continues to move toward the bait near the rear of the cage 10, the animal will inherently push the trigger 30 toward the back wall 20, which releases the catch leg 32 and causes the door 24 to pivot by gravity to the closed. position. When the door 24 pivots down to the closed position, the ring or rings 26 automatically slide down to the bottom of the door 24, and thereby retain or lock the door 24 in the closed position, thereby trapping the animal in the compartment 12 inside the cage 10. Also, when the door 24 moves to the closed position, the door leg 34, connecting rod 36, and catch leg 32 pull the trigger 30 upwardly to a stored position inside the guard. 38 at the top of the cage. The trapped animal can be released through the rear release door, or through the front door 24 if the animal is in front of the trigger arms 30 (since the arms 30 move down then the door 24 opens up).

When the trap is set, downward force on the opened door 24 will not release the catch leg 32. This safety feature is present since the connecting rod 36 pulls in a straight or horizontal line so that any downward force on the door merely has a horizontal force on the connecting rod 36 and the upper end of the catch leg 32, which engages the rear edge of the catch mounting or retention plate 37, without being pulled over the mounting plate. The catch leg 32 will release from the mounting plate 37 only when the trigger 30 is pushed rearwardly, which pivots the catch leg 32 over the rear edge of the mounting plate 37, so that the door 24 will close by gravity.

The trap will also remain set even if an upward force is exerted on the open door by an animal's back or nose, contrary to prior art traps wherein an upward force on the door actuates the trap to close the door.

Thus, the door 24 can only be opened when the ring or rings 26 are slid upwardly to the top of the door, and the door 24 can only close when the trigger 30 is pushed rearwardly to release the catch leg 32 from the catch mounting plate 37. Thus, the trap 10 cannot be accidentally released from the set position, and an animal cannot force its way out the front door 24 since the animal cannot lift the rings 26 from their position at the bottom of the door. Also, the trap 10 has no springs, as in many prior art traps, which create potential hazards when setting the trap, moving a set trap, or releasing a trapped animal.

The front end of the trap 10 may include a protective flange 40 (shown in broken lines in FIGS. 1 and 2 for clarity) to prevent damage to the door 24 and the leg 34 during transport. The upper or top section of the flange 40 has a slot through which the door leg 34 slides during opening and closing of the door 24. The trap 10 also includes a handle 42 on the top 16 to carry the trap with or without an animal inside the cage. Preferably, the handle 42 is pivotally connected to the cage so as to fold flat when not in use.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A live animal cage trap, comprising:
a compartment defined by a front wall, a rear wall, opposite side walls, a top, and a bottom;
a door in one of the walls, and being pivotally connected at an upper edge for pivotal movement between open and closed positions;
a lock connected to the door and slidably movable between a lock position adjacent a lower edge of the door to prevent the door from opening and an unlock position adjacent to an upper edge of the door to allow the door to open;
a trigger pivotally mounted to the top for movement between a raised position and a lowered set position extending into the compartment;
the trigger and the door being interconnected such that moving the door to the open position automatically moves the trigger to the set position; and
whereby actuation of the trigger by an animal in the compartment releases the trigger from the set position and thereby closes the door to entrap the animal.

2. The animal cage trap of claim 1 further comprising a rod extending between the door and the trigger, so that the door, the rod, and the trigger function together as a continuous and integral unit.

3. The animal cage trap of claim 1 wherein the door moves from the open position to the closed position by gravity.

4. The animal cage trap of claim 1 wherein the lock includes a pair of rings on opposite side edges of the door and a bar extending between the rings,

5. The animal cage trap of claim 4 wherein the rings move from the unlock position to the lock position by gravity.

6. The animal cage trap of claim 1 further comprising a guard in the compartment to receive the trigger in the raised position.

7. The animal cage trap of claim I wherein the trigger and the door are free from any spring energy.

8. The animal cage trap of claim 1 wherein the trigger is positioned adjacent the top of the compartment when the door is the closed position.

9. The animal cage trap of claim 1 wherein the compartment has opposite ends, and the door is pivotally connected to one of the ends.

10. The animal cage trap of claim 1 wherein the door has no spring.

11. The animal cage trap of claim 1 further comprising a rod interconnecting the door and the trigger such that the trigger and door move together.

12. The animal cage trap of claim 11 wherein the rod remains connected to the door and the trigger when the trigger is tripped.

13. A live animal cage trap, comprising:
a cage with a door moveable between a raised open position and a lowered closed position;
a trigger inside the cage moveable between a raised tripped position and a lowered set position;
a catch on the trigger to selectively hold the trigger in the set position; and
a rod connected to the catch and to the door to maintain the door in the open position when the trigger is in the set position;

14. The live animal cage trap of claim 13 wherein the door is pivotally mounted at an upper edge, and the rod is connected to the door adjacent to the upper edge.

15. The live animal cage trap of claim 13 further comprising a lock slidably mounted on the door and moveable between a raised unlocked position when the door is opened and a lowered locked position when the door is closed.

16. The live animal cage trap of claim 15 wherein the cage includes a door frame and the lock slides along the door frame and along the door as the door moves between the open and dosed positions.

17. The live animal cage trap of claim 13 wherein the rod is connected to the trigger and to the door when the trigger is in the tripped position and in the set position.

18. The live animal cage trap of claim 13 further comprising a channel inside the cage to house the trigger in the raised tripped position.

19. The live animal cage trap of claim 13 wherein the door is free from spring forces.

20. The live animal cage trap of claim 13 wherein the door is mounted to one end of the cage.

21. A live animal trap, comprising
a cage;
a door on the cage moveable between open and closed positions;
a trigger on the cage moveable between set and unset positions; and
a guard on the cage for guarding the trigger in the unset position.

22. The live animal cage of claim 21 wherein the guard includes a channel having a profile substantially corresponding to the profile of the trigger.
